(19) United States
(12) Patent Application Publication
(10) Pub. No.: US 2011/0029366 A1
(43) Pub. Date: Feb. 3, 2011

(54) METHOD AND APPARATUS FOR IDENTIFYING CUSTOMERS FOR DELIVERY OF PROMOTIONAL MATERIALS

(76) Inventor: ROBERT BERNSTEIN, NORTHIELD, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/692,930

(22) Filed: Jan. 25, 2010

Related U.S. Application Data
(63) Continuation of application No. 09/777,098, filed on Feb. 5, 2001, now abandoned.
Application No. 09/777,098 is a continuation-in-part of application No. 09/679,083, filed on Oct. 4, 2000, now abandoned.

(51) Int. Cl. G06Q 30/00

(52) U.S. Cl. 705/14.25; 705/16; 705/1.1

(57) ABSTRACT

A method and apparatus are provided for identifying potential customers for delivery of promotional messages or materials. The method includes the steps of a programmed transaction processor tracking purchases of consumers based upon summaries of purchases from consumers and vendors, a third-party tax record database that receives summaries of purchases from the transaction processor, the received summaries forming data files about customers where the third-party database is separate from any vendor and where the third-party database also determines a tax due on previous purchases made by customers, a programmed central processing unit of a vendor forming a customer profile for targeting delivery of the promotional materials to potential customers, a programmed comparator of the database of the third party searching the formed files within the database and identifying customers which match the customer profile within the database of the third party and a programmed processor forwarding promotional materials to the identified customers, the programmed processor detecting a purchase by a customer of the identified customers and printing out the promotional materials at a point of sale of the purchase.

### FIELD OF THE INVENTION

The field of the invention relates to marketing and more particularly to identification of potential customers for delivery of marketing messages and materials.

### BACKGROUND OF THE INVENTION

This application is a continuation of U.S. patent application Ser. No. 09/777,098 (pending) filed on Feb. 5, 2001 which is a continuation in part of U.S. patent application Ser. No. 09/679,083 filed on Oct. 4, 2000 (abandoned) and U.S. patent application Ser. No. 09/195,467 (now U.S. Pat. No. 6,298,335) filed on Nov. 28, 1998.

The field of marketing and distribution of promotional materials is generally known. Typically, marketers target a particular market segment and then search for a communication medium most likely to reach the targeted buyer. For example, buyers may preferentially subscribe to particular magazines or listen to one particular radio station over others. By distributing messages and promotions through selected media, the marketer attempts to have a maximum impact on the targeted market segment. However, much of this advertising and promotion is wasteful to the vendor because a large percentage of the magazine's readers and radio station's listeners are not among the vendor's current or potential customers.

Other local media, such as radio or television, typically tailor their content to the broadest possible audience, thereby limiting a marketer's ability to target a particular type of buyer. Further, the availability of streaming audio (or video) over the Internet virtually eliminate any regional limitations to radio or television broadcasting.

In addition, the use of the Internet for marketing has further increased the difficulty of targeting potential buyers for the distribution of advertising materials. The right to privacy further complicates the unrestricted distribution of buyer information to vendors.

While the distribution of marketing messages and materials under the prior art is effective, it is extremely inefficient. Accordingly, a need exists for a better method of distributing promotional materials to potential buyers.

### SUMMARY OF THE INVENTION

A method and apparatus are provided for identifying potential customers for delivery of promotional messages or materials. The method includes the steps of a programmed transaction processor tracking purchases of consumers based upon summaries of purchases from consumers and vendors, a third-party tax record database that receives summaries of purchases from the transaction processor, the received summaries forming data files about customers where the third-party database is separate from any vendor and where the third-party database also determines a tax due on previous purchases made by customers, a programmed central processing unit of a vendor forming a customer profile for targeting delivery of the promotional materials to potential customers, a programmed comparator of the database of the third party searching the formed files within the database and identifying customers which match the customer profile within the database of the third party and a programmed processor forwarding promotional materials to the identified customers, the programmed processor detecting a purchase by a customer of the identified customers and printing out the promotional materials at a point of sale of the purchase.

### BRIEF DESCRIPTION OF THE DRAWINGS

FIG. 1 is a block diagram of a system for distributing promotional materials in accordance with an illustrated embodiment of the invention;

FIG. 2 depicts a customer profile that may be used by the system of FIG. 1;

FIG. 3 depicts a system for tracking taxable events that may be used with the system of FIG. 1;

FIG. 4 depicts a screen that may be presented by a website of the system of FIG. 3;

FIG. 5 depicts a summary purchase screen that may be used by the system of FIG. 3;

FIG. 6 depicts a message packet that may be used by the system of FIG. 3;

FIG. 7 is a block diagram of a third party database used by the system of FIG. 3;

FIG. 8 depicts a system used for payment of debt that may be used by the system of FIG. 1; and

FIG. 9 depicts the system of FIG. 8 coupled to a vendor.

### DETAILED DESCRIPTION OF AN ILLUSTRATED EMBODIMENT

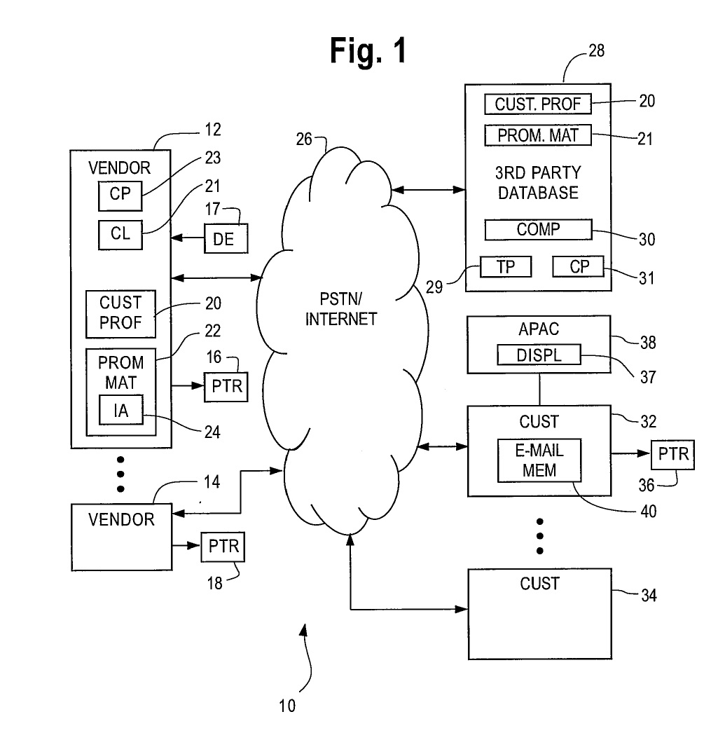

FIG. 1 is a block diagram of a system 10, shown generally, which allows vendors 12, 14 to identify potential customers 32, 34. While FIG. 1 shows two vendors 12, 14 and two customers 32, 34, it is to be understood that any number of vendors 12, 14 and any number of customer 32, 34 have access to the public switched telephone network (PSTN)/Internet and a relationship with a third-party database 28.

The use of the system 10 allows vendors 12, 14 and customers 32, 34 to interact at any chosen level. Interactions may occur based upon a targeted locale, interest, or under any other chosen criteria.

The third-party database 28 may be any database which tracks financial transactions of buyers 32, 34 and which accepts customer search profiles from vendors 12, 14. The third-party database may be the third-party payment scheduler and tax record database described below. Alternatively, the database may be a financial institution acting as a clearinghouse for transactions under a variety of different formats (e.g., cash, credit, charge, promise, debit, etc.).

Under the illustrated embodiment, a customer (i.e., a buyer) 32, 34 may periodically interact with vendors 12, 14 directly, by face-to-face contact, or through the PSTN/Internet 26. Where the contact is face-to-face, payment may be made from the customer 32, 34 to the vendor 12, 14 for goods and services using the automatic portable account controller (APAC) 38 (e.g., a smartcard or the interactive device described in more detail below. Alternatively, the contact may be by telephone or through the Internet 26. In either case, a summary of the transaction may be generated and stored in the database 28.

Based upon the interactions between the customers 32, 34, and at least some of the vendors 12, 14, the database 28 may accumulate information regarding the buying preferences and habits of the individual customers 32, 34. Alternatively, the customers 32, 34 may request and complete a questionnaire of preferences and buying habits, which, in turn, may form a portion of the information within the database 28.

From time to time, a vendor 12, 14 (e.g., 12) may desire to expand its customer base by distributing promotional materials (e.g., coupons, special price lists, catalogs, etc.) to potential customers 32, 34. In order to identify potential customers, the vendor 12 may form a customer profile 20. The vendor (not shown) may form a customer profile using a data entry device 17 (e.g., a keyboard and display). Alternatively, a CPU functioning as a customer profiler 23 may analyze past sales to form a profile of customers which are likely to patronize the vendor 12.

The customer profile 20 may incorporate any of a number of limitations specific to the type of customer 32, 34. For example, if the vendor 12 markets locally, then the profile 20 may include a limitation that identified customers 32, 34 live in or have a history of purchasing in the locale where the vendor 12 sells. Further, the vendor 12 may include limitations that identified customers 32, 34 have previously purchased complementary products or services in the locale where the vendor 12 sells. For example, if a customer likes pizza, then a complementary product may be beer. Alternatively, if a customer 32, 34 purchases gas at a particular location, then complementary products may be convenience products offered through a convenience store in the area.

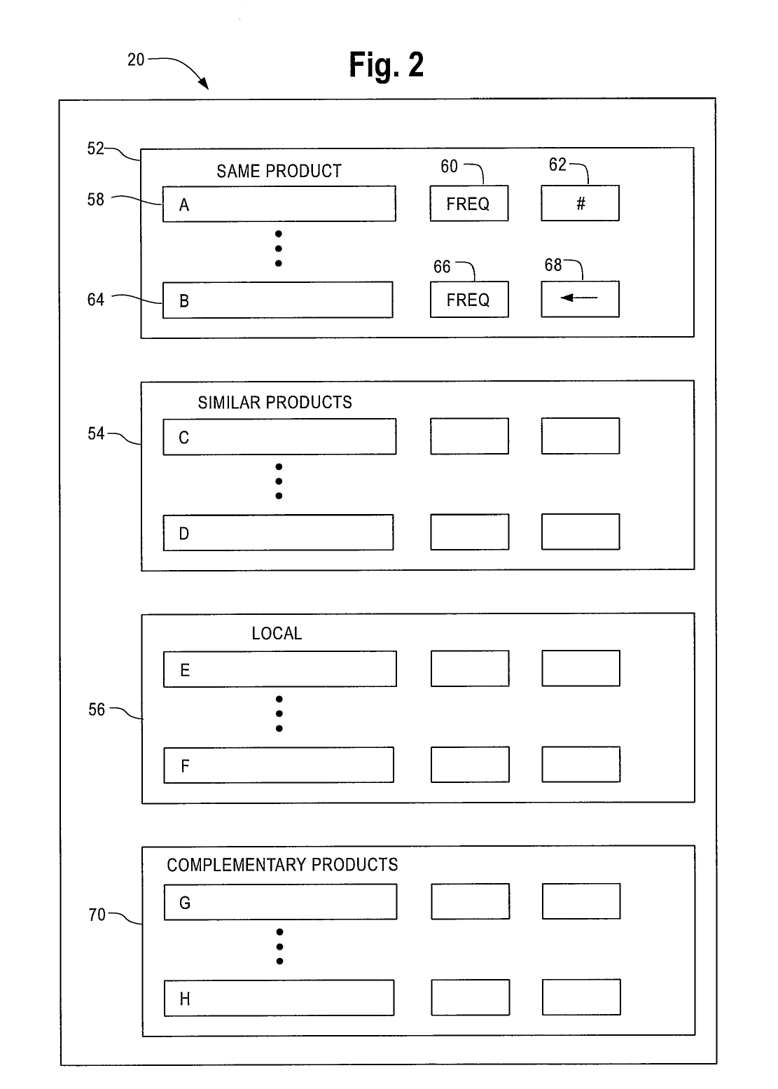

FIG. 2 provides a summary of a customer profile 20. Included within the customer profile 20 may be limitations including purchases of the same products 52, similar products 54, a locale of purchases 56 or complementary products 70. Each limitation may include a minimum frequency of purchase 60, 66 or even a dollar value 62, 68.

Upon forming the customer profile 20, the vendor 12 may transfer the profile 20 to the database 28. Within the database 28, a comparator 30 may function to compare the profile 20 to the buying habits and other information of any of a number customers 32, 34. The database 28 may return a customer list 21 of the customers 32, 34 with the closes match to the requesting vendor 12.

In order to preserve the privacy of the customers 32, 34, the database 28 may release customer information to the vendor 12 in summary form only. For example, the database 28 may limit the release to contact information about identified customers 32, 34 which meet the limitations of the customer profile 20. The contact information (i.e., customer list 21) may be downloaded to the vendor 12.

Alternatively, customer privacy may be protected by uploading the promotional material 22 from the vendor 12 to the database 28. The database 28, in turn, may function to distribute the promotional material.

In either case, a communication processor 31 within the database 28 or vendor 12 may distribute the promotional materials 22 under any of a number of different formats. For example, where the contact information provides an e-mail address of the customers 32, 34 on the contact list 21, the database 28 or vendor 12 may send an e-mail to the customers 32, 34 on the customer list 21 containing the promotional materials 22.

To prevent fraud, the promotional materials may be customized for each customer on the customer list 21 by the addition of indicia of authenticity (e.g., a serial number) provided by the vendor 12. Where the promotional materials 22 were directly distributed to customers 32, 34 by the vendor 12 and then presented for redemption to the vendor 12, the vendor 12 may compare the indicia 24 with its own internal distribution list to determine authenticity. Alternatively, where a summary of the transaction is sent to the database 28, the database 28 may compare the indicia 24 with its own records to ensure that the indicia 24 was distributed to the customer 32, 34 presenting the materials 22 for redemption.

In the alternative, other methods may be used to distribute the promotional materials 22. For example, where the database retains the customer list 21, a transaction processor 29 within the database 28 may examine a customer identifier of each incoming purchase transaction. Where a match is found between the customer 32, 34 and an entry on the customer list 21, the database 28 may download the promotional material 22 directly to a printer 16, 18 of the vendor 12, 14.

Alternatively, the promotional materials 22 may downloaded to the APAC 38 at the point of sale. The customer may then scroll through and view the promotional materials as appropriate to the circumstance.

For example, where a first vendor 12 is offering the promotional materials 22 and a customer 32 make from another vendor 14, a summary of the purchase may be sent to the database 28. The database 28 may compare a customer identifier from the summary of the purchase with the customer list 21. If a match is found, the database 28 may download the promotional materials 22 to the printer 18 of the vendor 14. The promotional materials 22, in fact, may be printed on the back of a sales receipt provided by the vendor 14 at the point of sale.

As a further example, consider a television (TV) vendor, a pizza store and a liquor store. A TV vendor, pizza store and liquor store are unlikely to market together. The TV vendor is a mass marketer, the pizza store would likely be small and local, and the liquor store is not likely to hook up with the pizza store, much less a TV vendor.

Consider a customer of the TV vendor, who is given promotional materials from the other stores while buying a new TV. Alternatively, consider a customer of the liquor store being given a pizza or TV offer while buying beer. All of these scenarios are possible and appropriate when the consumer is hosting a party for watching a TV program (like the Superbowl or other sporting event). In the past, none of the three merchants would cross-promote because they didn't have the means or the information to do so. Prior art systems were unable to be highly targeted and offer real time promotional opportunities because their data was not integrated. If the TV is bought at “Best Buy” on a store charge, then it would be invisible to the credit card company. Cash purchases at the pizza store would also be left out. A check for the liquor store would similarly be left out of the loop.

In order to reach customers, vendors have used a “shotgun” approach to market for the masses (like Superbowl ads that are shown to everyone) or highly targeted narrow promotions that fail to reach their targeted market. (Print advertising or radio ads are not read or heard by everyone who the vendor would like to reach.) By integrating data from all modes of payment using the database 28, it is possible to efficiently market to a highly specific consumer at a time of purchase.

The distribution of promotional materials 22 at a point of sale may have great value in the case of transient customers. For example, the customer profile 20 may correlate the one-time check-in of a customer 32, 34 into a local hotel with distribution of promotional materials. In this way, a local eatery may notify a newcomer to the area of his establishment without the necessity of mass advertising. The promotional materials 22, as above, may be printed on the back of a separate receipt from the hotel or e-mailed to the customer for pick-up at his convenience at a convenient e-mail terminal (possibly provided by the hotel).

Alternatively, the promotional materials may be presented on an in-room television or through voice mail. When presented in the form of voice mail, the materials may include some sort of indicia of authenticity “Irma told me about this offer”.

Under other illustrated embodiments, a customer 32, 34 may pay a monthly fee to the database 28 to be provided with promotional materials 22 that are specific to their overall buying histories. In this case, the customer 32, 34 may provide his own customer profile 20 of products which that customer 32, 34 may want to receive. The customer 32, 34 may receive the promotional materials by any appropriate medium (e.g., e-mail, direct mail, point of sale print-out, etc.).

Consumers currently are exposed to vast amounts of unsolicited and wasteful marketing. Using the system 10 described above, it is possible for a consumer to receive, or subscribe to a service that offers, highly specific buying opportunities.

On the vendor side, there is enormous efficiencies to be gained by using the integrated data of the database 28. These efficiencies translate into avoidance of wasted marketing money and into customer savings opportunities. Small vendors can find low cost, but highly effective, opportunities that are currently beyond their reach.

Under the system 10 described above, promotions may be based upon any of a number of prior purchases (e.g., checks, cash, tokens, store charges, accumulated points plans, credit card purchases, etc.). A customer of a toll road automatic payment system (e.g., I-Pass) who uses a bridge or toll road segment, can be given restaurant or motel promotions based on his payments, location, direction, and past motel or restaurant charges. These promotions can be for commonly used items like audio tapes of books or cellular phones that operate in cellular ranges that encompass an entire itinerary. Further, 3-g cellular phones may be provided in conjunction with GPS and the system 10 to provide enhanced promotions based upon geographic position.

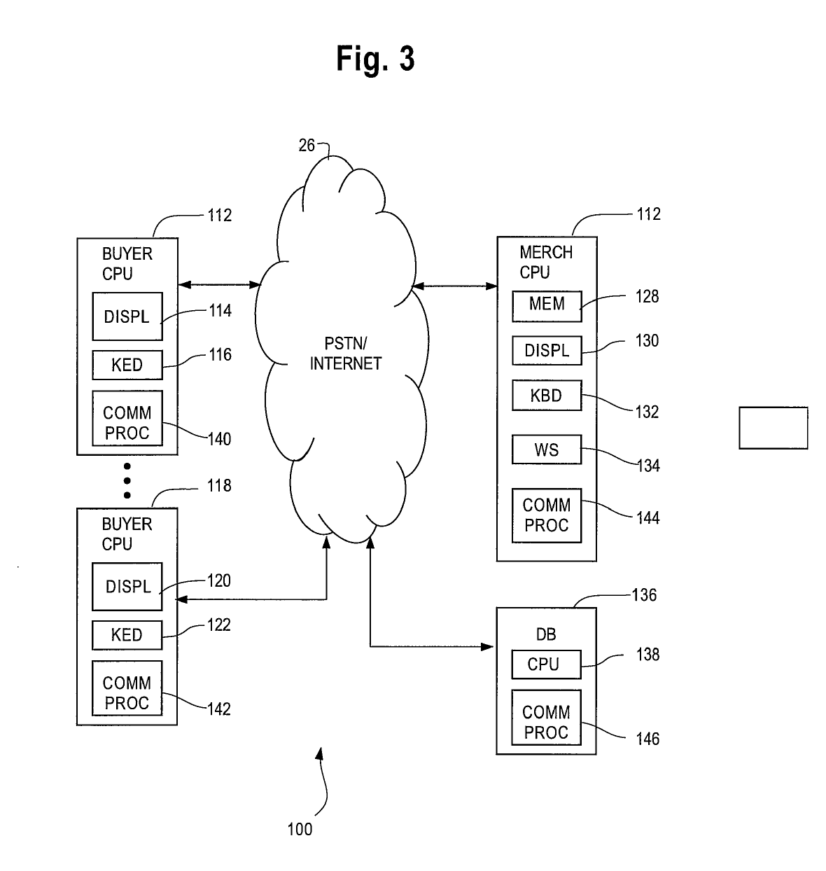

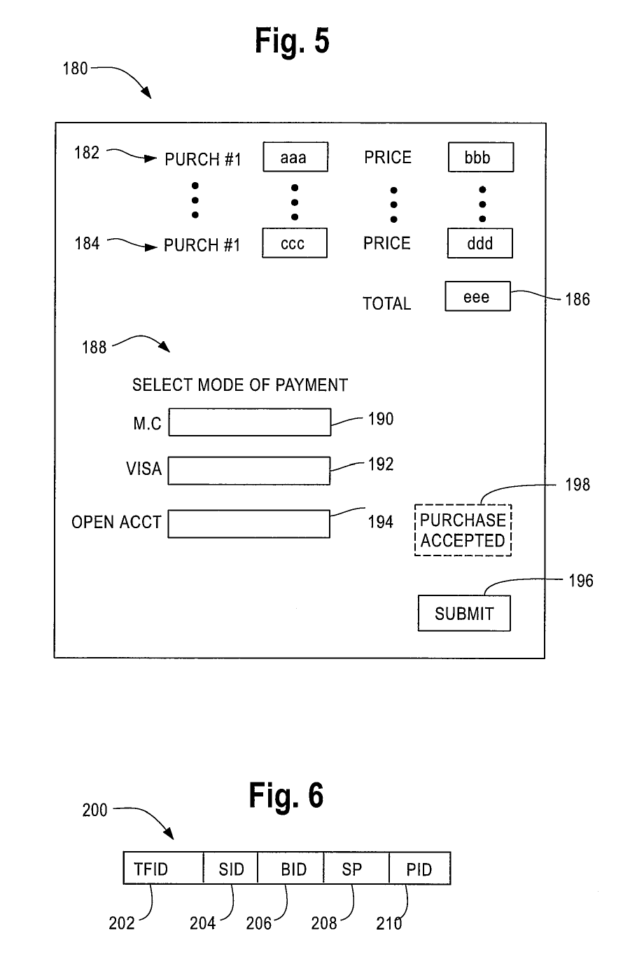

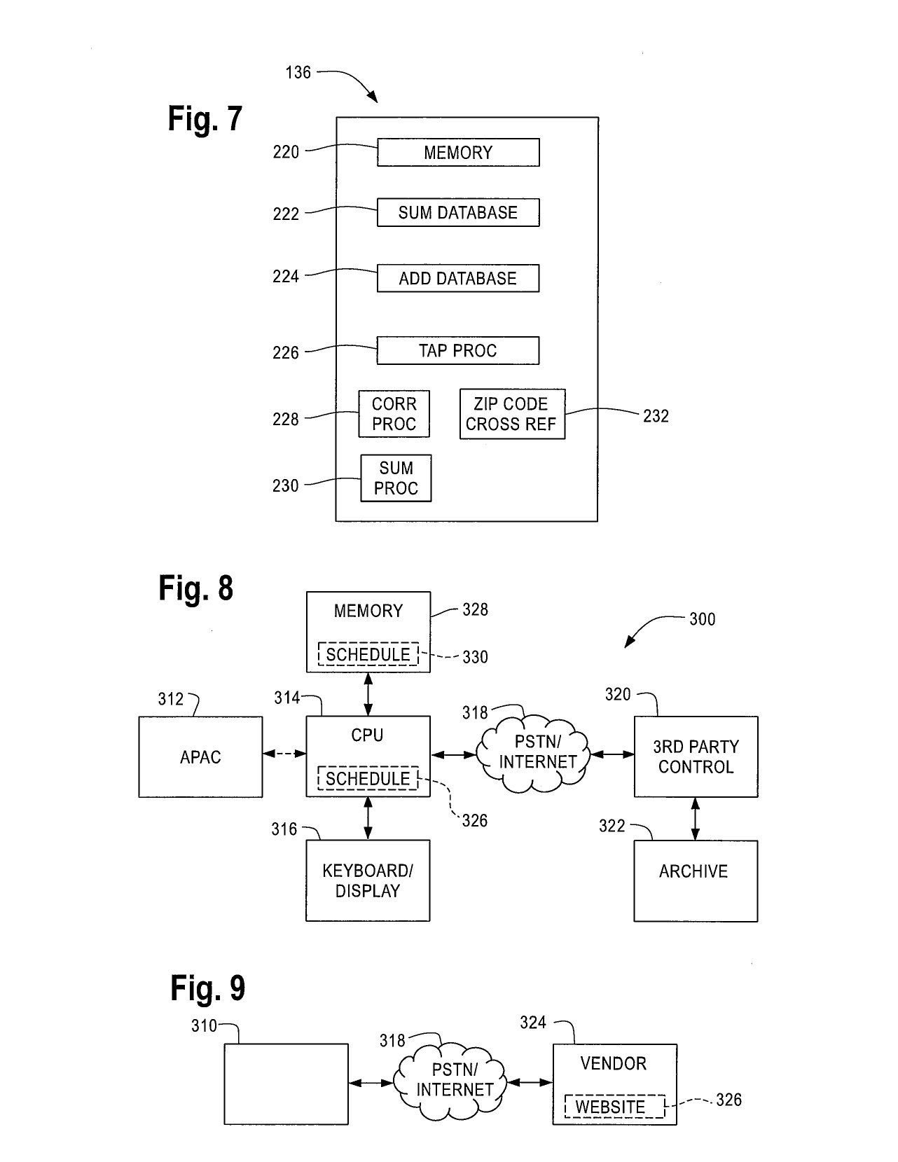

In another illustrated embodiment, the third party database 28 is generated by a system 100 for tracking taxable events. FIG. 5 is a block diagram of a system 100, shown generally, for tracking taxable events in accordance with an illustrated embodiment of the invention. Included within the system 100 may be a number of merchants (sellers) doing business through sellers central processing units (CPUs) 126 (one shown in FIG. 3) and a number of buyers using CPUs 112, 118. Buyers 112, 118 and sellers 126 may be able to negotiate sales through the Internet 124 or any other appropriate communications medium (e.g., telephone, facsimile, a local area network (LAN), a wide area network (WAN), Ethernet, etc.).

Sellers 126 may advertise product using any of a number of different formats (e.g., mass media advertising campaigns, mailings, product literature displayed on a web site, e-mail proposals, etc.). Once a buyer 112, 118 has been apprised of a product, the buyer 112, 118 and seller 126 may negotiate sales terms under appropriate format (e.g., interactive webpage, e-mail exchange, telephone, facsimile exchange, etc.).

Similarly, arrangement for payment for purchased product may be made using any appropriate medium (e.g., interactive webpage, e-mail, telephone call, etc.) based upon an open account, credit card, debit card. Payment may also be made by check or cash.

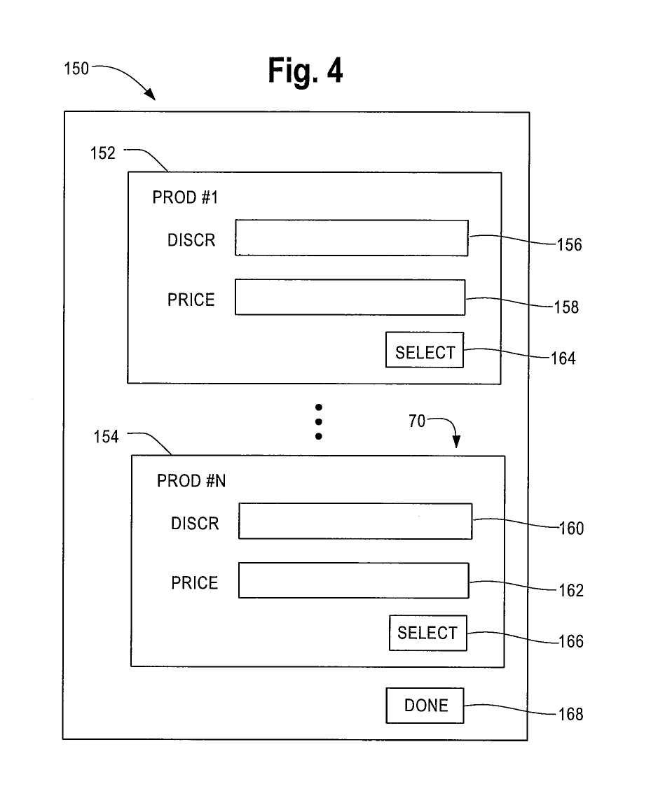

As a simplified example, a buyer 112, 118 may access a website 134 of the seller 126 using a simple web browser and be presented with a product selection webpage 150 (FIG. 4). Within the product selection webpage 150 may be product descriptive information 152, 154 of any of a number of different products. Included within the product descriptive information 152, 154 may be a product description 156, 1160 and a price 158, 1162.

To make product selection, the buyer 112, 118 upon viewing the product literature through a display 114, 120, may place a cursor 70 over a select button 1164, 1166 and select one or more products 152, 154. Upon completion of a session, the buyer 112, 118 may place the cursor 70 over a DONE button 1168 to complete a purchase.

Upon selecting the DONE button 1168, the summary screen 180 of FIG. 5 may be transmitted from the website 134 to the buyer 112, 18 for presentation on the display 114, 120 of the buyer 112, 118. Included within the summary screen 1180 may be an entry 182, 184 for each purchase.

Also included on the summary screen 180 may be a request for a mode of payment. To select a mode of payment, the buyer 112, 118 may place the cursor 70 over an entry window 190, 192, 194 and enter a credit card number. Upon entry of a credit card number the buyer 112, 118 may activate a SUBMIT button 196.

Upon activation of the SUBMIT button 196, the summary page 180 may be forwarded to the CPU 126 for processing. The CPU 126 may verify the credit of the buyer 112, 118. Upon satisfying any internal requirements, the CPU 126 may transmit a copy of the webpage 180 back to the buyer 112, 118 with a highlighted PURCHASE ACCEPTED notice 198.

To conform with applicable tax laws both the seller 126 and the buyer 112, 118 transmit summaries of the purchase to a secure database 136. As used herein, a secure database means a database under the control of a third party (e.g., a third party tax auditor, third party database provider, etc.). A secure database may also be a captive database of the seller with security features which prevents alteration of data or which provides an audit trail of data which has been altered.

The CPU 126 and CPU 112, 118 receive the information of the summary page 180 and compose a packet message 200 (FIG. 6) for transmission to the database 136. Included within the message 200 may be an Internet protocol (IP) address 202 of the database 136. Also included may be an identifier of the seller (SID) 204. The SID 204 may be any appropriate identifier of the seller (e.g., an IP address, a geographic address with zip code, etc.).

Also included within the packet message 200 may be a buyer's identifier (BID) 206. As with the seller, the BID 206 may be any appropriate identifier of the seller (e.g., an IP address, a geographic address with zip code, etc.).

Finally, the packet message 200 may include a sales price (SP) 208 and product identifier (PID) 2100. The sales price may be included for calculation of a sales tax. The PID 2100 may be included for purposes of tax multipliers (e.g., on tobacco, liquor, etc.). The PID 206 may be a Universal Product Code (UPC) identifier or any other universally recognized identifier code.

Upon preparation of the message 200, a communication processor 140, 142, 144 transfers the message 200 from the buyers 112, 118 and seller 126 to the third party database 136. Upon receipt by the database 136, the message 200 may be stored in memory 220 or processed immediately.

When processed, the message 200 may be parsed and the components 204, 206, 208, 210 are used for different parts of the tax calculation for the purchase. For example, the PID 2100 may be used as a search term for entry into a subject matter (SM) database 222. Within the SM database 222, the PID 2100 may be used to retrieve a tax rate for the subject matter of the purchase.

The BID 206 and SID 204 may be used to access an address database 224 or (where used) a zip code cross reference 232 to identify a local of both buyer and seller. The address database 224 may be used to identify a municipality to identify any applicable tax adders and the dividing lines between taxing entities. The zip code cross-reference may be used for the same purpose, except by starting with a different type of identifier.

Once, the locals of the buyer and seller have been identified and the subject matter of the transaction identified, the information may be transferred to a tax processor 226. Within the tax processor 226 the total tax on the purchase may be determined based upon the transferred information. It is anticipated that in some locals, a tax will be due for both the seller's local and the buyer's local. In other tax areas, the buyer or seller's local may receive the tax. The subject matter of the transaction may affect each calculation.

Once a tax is calculated, the tax due may be, again, stored in memory 220. Periodically, a summary of the tax due may be prepared by a summary processor 230 and forwarded to the seller 126. The summary may be broken down by time period and also based upon the entity to which the tax is due.

While the message 200 transferred from both the seller 126 and buyer 112, 118 to the database 136 may be redundant, the redundancy serves an important purpose by improving the reliability of the system 100. Accordingly, where a first message 200 is located, a CPU 138 of the database 136 automatically searches for its copy. Since Internet packets typically contain both source and destination information, the CPU 138 may use the presence of any unmatched message 200 as an indication of a malfunction within a CPU of a second party to the transaction.

Where the source information of the packet 200 matches the BID 206, the CPU 138 may determine simply generate a malfunction message for handling by others. However, when the source information of the packet 200 matches that of the SID 204, this could be the indication of a malfunction in the CPU 126 of the seller or an indication that the seller is attempting to commit fraud. Based upon this information, appropriate measures may be taken.

In another illustrated embodiment of the system 100, the transaction may be consummated by methods other than a web browser and the Internet (e.g., by telephone, facsimile, e-mail, etc.). For example, a purchase may be completed by telephone or by e-mail without the formal screens of the website 134. In those cases, the CPUs of the buyer 112, 118 and seller 126 may be manually triggered to provide the screen 180. Information regarding the purchase may be entered. The SUBMIT button 196 in this case trigger the CPU 112, 118, 126 to compose the packet 200. The packet 200 may then be transferred to the database 136 and the process may be repeated as above.

The use of the database 136 has important implications for both buyer and seller. For buyers, the database may be used as a convenient source of information on purchases for tax purposes. It may also be used for detecting credit card fraud.

For example, duplicate charges from the same seller may be regarded as evidence of fraud. The tracing of charging patterns by time of day, geographic area or account number may provide further evidence. The detection of charges on a single account, closely related in time from geographically diverse locations may provide other evidence.

Sellers benefit from the convenience of a single source for tax payment information. Tax audits may become less necessary because of the additional reliability provided by cross-checked buyer and seller messages.

The third party database 136 may cover expenses by imposing a nominal charge on each seller 126. Further revenue may be derived from the vast quantities of consumer buying information generated and which may then be sold under certain conditions to marketing organizations. A specific embodiment of a method and apparatus for tracking taxable events according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

In another illustrated embodiment, the APAC 38 may be used in the system 300 illustrated in FIGS. 8 and 9. FIG. 8 is a block diagram of a payment system 300, generally, for executing payment of debts. Included within the system 300 is a central processing unit (CPU) 314 and a keyboard/display unit 316. Shown optionally connected to the system 300 is an automatic portable account controller (APAC) 312, such as a smartcard.

While it is believed that the utility of the system 300 lies primarily in its ability to facilitate payment of debt, the system 300 may also be used for the incursion of debt. The system 300 may incur debts directly or through operation of the APAC 312. For example, the APAC 312 may be used to purchase merchandise on credit and store a record of the transaction within an internal memory.

A keyboard of the APAC 312 allows memorandums to be created and associated with each purchase and stored in an internal memory of the APAC 312 along with the record of the purchase. Following use, the APAC 312 may be coupled to the CPU 314 as shown in FIG. 8 where a record of the transaction(s) may be downloaded and stored in a memory 328. Any agreed-upon payment dates may be loaded into a payment schedule 330.

To protect the integrity and viability of the purchase process, a number of electronic receipts may be created and retained in a number of diverse locations. The ability to create and maintain a number of substantially identical receipts adds to the security of the system 300, enhances the perceived reliability and reduces the risk to both user and vendor.

For instance, under one purchase scenario, the APAC 312 is coupled to a vendor's payment receiving system during which payment information is exchanged. Following receipt of the payment information, the vendor may transfer an electronic receipt to as many as four separate locations. First, the vendor 324 keeps a receipt of the transaction in his own system. Second, the vendor (using the routing information received from the APAC 312) sends an electronic receipt to the third party 320. A third receipt is transferred to the APAC 312 as part of the transaction. A final receipt (again using the routing information received from the APAC 312) may be sent to the CPU 314 of the user.

The transfer of the first and third receipt may be accomplished through a simple store routine by the vendor 324 and APAC 312 at the point of sale. The second and fourth receipts may be composed and forwarded by the vendor from the point of sale. Software within the vendor's system composes a summary of the transaction. The vendor sends the summary as a message through the Internet to both the third party 320 and to the CPU 314. Should a dispute arise, the vendor has not only his own receipt, also the receipt retained by the third party 320. The receipt stored in the CPU 314 of the user provides additional evidence of the transaction.

As a further option for the retention of receipts of transactions, the APAC 312 may also forward a copy of the receipt to an archive 322, either through the third party 320 or through a separate connection with the Internet 318. The availability of separately verifiable receipts in a number of locations precludes the possibility of fraud on the part of either user or vendor.

Under another alternative manner of use, the user of the system 300 may also incur debt from a remote location through use of the CPU 314. Where debt is incurred remotely, a receipt may be stored by the CPU 314 directly in memory 328. Other receipts may be forwarded from the vendor to the third party 320 or from the CPU 314 to the archive 322. The keyboard 316 of the CPU 314 may also be used to enter additional information about the transaction (e.g., a vendor's name, notes about the purchase, purpose of the purchase, etc.).

For instance, the CPU 314 may be used to access a website 326 of a vendor 324 (FIG. 9). The website 326 may provide information of a particular product sought by a user of the system 300. Upon examining the information provided by the vendor, the user may decide to purchase the product.

To facilitate a purchase by the user directly from the CPU 314, the vendor may provide an interactive webpage with provisions for entry of a product description or part number. Upon entry of an appropriate description, the user may select a “request quotation” softkey. The vendor may respond with a product cost and request for payment. The user may then negotiate payment terms.

Negotiation of payment may include one or more offers by the user (i.e., the buyer) of any of a number of purchase options. The buyer may offer payment by credit card, debit card, electronic check, extended check settlement (ECS) or any of a number of other purchase plans. The vendor 324 (i.e., the seller) may accept one of the payment offers made by the buyer, or may offer other alternatives (e.g., time payment plan, layaway, etc.).

As used herein, an electronic check differs from a debit card in that the debit card results in an instantaneous transfer of funds. In contrast, an electronic check is a promise of payment payable upon demand when a copy of the electronic check is presented to the third party 320 of the user. Credit card purchases are assumed to be payable within thirty days of receipt of a bill or later with additional finance charges.

ECS simply refers to a check with an agreed-upon presentation date. The buyer and seller may agree that the seller will not present the check for payment for some extended period (e.g., 30 days, 60 days, etc.). Presentation of the check outside the agreed-upon time periods may be regarded by the buyer as a breach and may be refused payment, absent new consideration from the seller.

To facilitate payment, the vendor 324 may provide the buyer with a webpage summarizing various acceptable payment options. The buyer may propose other options or select an offered mode of payment (e.g., credit card) and may enter any requested information (e.g., a credit card number).

Sensitive information (e.g., the credit card number or PIN number) may be transferred to the vendor under an encrypted format. Encryption may be by public key or any other appropriate format.

Where the offer is a credit card purchase, the vendor may receive the credit card number and separately request an authorization number from the credit card provider. The credit provider may decode any transferred information and respond accordingly. If the card were over a credit limit the provider may notify the vendor 324 and the vendor 324 may decline the purchase offer and request that the buyer select another form of payment.

In response, the buyer may select layaway. The vendor 324 may respond with a payment schedule showing a monthly payment amount and the number of payments required before the vendor would forward the merchandise. If the terms are acceptable to the buyer, the buyer activates a “PURCHASE” softkey to complete the transaction.

To complete the transaction, a number of data fields may be exchanged between buyer and seller. For example, the buyer may forward an identifier of a payment source 320 under the control of a third party. The vendor 324 may forward an identifier of a payment destination (which may be the same or a different third party). A unique transaction number may be generated by either the buyer or seller and associated with the transaction record of each party. Alternatively, a date and time-stamp and the names of the parties may be used as identifiers of the transaction.

The payment source 320 may be a credit card company, a bank, a credit union, a non-bank financial institution, or simply a clearinghouse created for payment of debts by electronic means. Similarly, the payment destination may also be a bank, credit union or clearinghouse for acceptance of payments. Where the third party 320 is a clearinghouse for payment of debt, it would be expected to be associated with a financial institution of sufficient financial stability to inspire confidence in the vendor. Where buyer and seller share the same entity, the payment would simply be an account transfer. Where the buyer and seller do not share the same entity, the financial stability of the third party 320 may be established by a policy from an appropriate private or public liability insurance carrier (e.g., from SIPIC, Lloyds of London, Metropolitan Life, etc.).

Upon completing the transaction, the user of the system 300 enters the payment schedule into a scheduler 326 within the CPU 314. Entry may be accomplished manually based upon the term forwarded by the vendor 324 or automatically by activation of the “PURCHASE” softkey. Upon presentation of the payment data, the payment scheduler accepts the payment date(s) and payment destination and enters the data into a payment schedule 330 in memory 328.

The user may also enter a record date and settlement date appropriate to the transaction. A record date is the agreed-upon date of payment. A settlement date is a time period within which the transaction will be honored based upon the circumstances. For instance, in the case of an ECS, the vendor 324 may deposit the ECS check in the U.S. Mail which may result in several days deviation on either side of the record date. For an ECS, the user may allow two or three days on either side of the record date within which the ECS will be honored. An electronic transfer may only be allowed one day for payment upon demand, except where a transaction was made late in the day (e.g., after 2 p.m.).

Each day, the scheduler 326 compares a current date with the payment schedule 330. Where a match is found, the scheduler 26 transfers a payment authorization to the third party payment controller 320.

The transfer of payments from source to destination accounts may be accomplished under any of a number of formats. For instance under a first format where buyer and seller have an ongoing relationship of trust (e.g., mortgagor, mortgagee), the transfer may be accomplished unilaterally by one side or the other. Alternatively, the transfer may be accomplished under a second format by receipt of an electronic demand for payment placed by the vendor 324 with the third party 320 and matched with an authorization for payment forwarded from the payment system 300.

In either case, the payment system 300 would electronically instruct the third party 320 to make a payment based upon terms of a prior agreement. Where the relationship was that of mortgagor/mortgagee, the underlying mortgage agreement would specify the payment terms.

To accomplish payment under the first format, the payment system 300 may perform a one-time transfer of authorization for monthly payments in the required amount. In response, the third party 320 may execute a monthly transfer to the mortgage holder or allow a monthly debit of the appropriate account.

Under the second format, the user of the system 300 would enter an amount of the payment and a payment date into the scheduler 326. On the payment date, the scheduler 326 would transfer a payment instruction to the third party 320. Upon matching the payment instruction to the payment demand, the third party 320 would transfer payment to the appropriate party.

To confirm payment of a debt (and to form a record of the transaction), the third party 320 transfers a receipt of payment to the payment system 300, to the vendor 324 and to an archive 322 in a secure location. The receipt transferred to the system 300 and vendor 324 confirms payment in accordance with the purchase agreement. The receipt held in the archive 322 forms a permanent record of the transaction.

Under one embodiment, the archive 322 is intentionally located remotely from either buyer or seller. While the archive 322 may be located in a facility of the third party 320, it may also be situated in a facility beyond the control of the third party 320 for purposes of additional security.

By using the system 300, a user may accumulate purchases over a time period and schedule payment according to any agreed-upon terms. Further by consolidating the payment of debt to a substantially single location, the user is much more able to maintain control over his financial condition.

For example, a user may schedule a monthly mortgage payment and may authorize the monthly payment without further action on the part of the user. As utility or credit card bills are received, the user may enter the payment amount and due date for payment. Other miscellaneous purchases, such as car repairs, medical bills or property taxes may be entered into the system 300 as bills are received and paid by the third party 320 in accordance with any agree-upon terms.

The third party 320 may pay the bills electronically as described above, or may generate a check in payment of the debt. Where the third party 320 generates a check, the check may be forwarded to the vendor through the U.S. Mail in a conventional manner.

By adding up purchases within a time period, the CPU 314 is much more able to present total expenditures to the user for a time period. Where the user enters his monthly income, the CPU 314 is able to present a clear picture of the user's financial condition, both near term and long term. Where a difference between the user's income and scheduled payments reaches some threshold difference, the system 300 may warn the user of a potential shortfall based upon the difference or may project a shortfall based upon additional historical expenses, such as utility or grocery bills.

A specific embodiment of a method and apparatus for providing promotional materials has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

What is claimed is:

1. A programmed computer method of identifying potential customers for delivery of promotional materials, such method implemented by the programmed computer to effect the following steps:
a programmed transaction processor tracking purchases of consumers based upon summaries of purchases from consumers and vendors;
a third-party tax record database that receives summaries of purchases from the transaction processor, the received summaries forming data files about customers where the third-party database is separate from any vendor and where the third-party database also determines a tax due on previous purchases made by customers;
a programmed central processing unit of a vendor forming a customer profile for targeting delivery of the promotional materials to potential customers;
a programmed comparator of the database of the third party searching the formed files within the database and identifying customers which match the customer profile within the database of the third party; and
a programmed processor forwarding promotional materials to the identified customers, the programmed processor detecting a purchase by a customer of the identified customers and printing out the promotional materials at a point of sale of the purchase.

2. The method of identifying potential customers as in claim 1 wherein the step of forwarding promotional materials further comprises printing out a coupon.

3. The method of identifying potential customers as in claim 1 wherein the step of forwarding promotional materials further comprises composing an e-mail to the identified customer.

4. The method of identifying potential customers as in claim 3 wherein the step of forwarding promotional materials further comprises providing indicia of authenticity within the promotional materials.

5. The method of identifying potential customers as in claim 1 wherein the step of forming the customer profile further comprises specifying a geographical locale of prior purchases made by the potential customers.

6. The method of identifying potential customers as in claim 1 wherein the step of forming the customer profile further comprises specifying a subject matter of prior purchases made by the potential customers.

7. An apparatus for identifying potential customers for delivery of promotional materials, such apparatus comprising:
a transaction processor that tracks purchases of customers based upon information of purchases received from customers and vendors;
a tax record database that receives purchase information from the transaction processor;
a customer profile provided by a vendor for targeting delivery of the promotional materials to potential customers;
means within the tax record database of a third party for identifying customers which match the customer profile where the database of the third-party is separate from the vendor and where the database is configured to determine a tax due on previous purchases made by potential customers; and
means for forwarding promotional materials or messages to the identified customers.

8. The apparatus for identifying potential customers as in claim 7 further comprising means for detecting a purchase by a customer of the identified customers.

9. The apparatus for identifying potential customers as in claim 8 further comprising means for printing out the promotional materials at a point of sale of the purchase.

10. The apparatus for identifying potential customers as in claim 7 wherein the means for forwarding promotional materials further comprises means for printing out a coupon.

11. The apparatus for identifying potential customers as in claim 7 wherein the means for forwarding promotional materials further comprises means for composing an e-mail to the identified customer.

12. The apparatus for identifying potential customers as in claim 11 wherein the means for forwarding promotional materials further comprises means for providing indicia of authenticity within the promotional materials.

13. The apparatus for identifying potential customers as in claim 7 wherein the means for forming the customer profile further comprises means for specifying a geographical locale of prior purchases made by the potential customers.

14. The apparatus for identifying potential customers as in claim 7 wherein the means for forming the customer profile further comprises means for specifying a subject matter of prior purchases made by the potential customers.

15. An apparatus for identifying potential customers for delivery of promotional materials, such apparatus comprising:
a transaction processor that tracks purchases of customers based upon purchase summaries received from customers and vendors;
a tax record database of a third party that contains customer purchasing information received from the transaction where the database of the third-party is separate from any vendor and where the database is configured to determine a tax due on previous purchases made by customers;
a data entry device configured to form a customer profile by a vendor of the plurality of independent vendors for targeting delivery of the promotional materials to potential customers;
a comparator configured to identify customers which match the customer profile within a database of a third party; and
a communication processor configured to forward promotional materials to the identified customers.

16. The apparatus for identifying potential customers as in claim 15 further comprising a transaction processor adapted to detect a purchase by a customer of the identified customers.

17. The apparatus for identifying potential customers as in claim 16 wherein the communication processor further comprises a printer adapted to print out the promotional materials at a point of sale of the purchase.

18. The apparatus for identifying potential customers as in claim 16 wherein the forwarding promotional materials further comprises indicia of authenticity provided within the promotional materials.

19. The apparatus for identifying potential customers as in claim 15 wherein the customer profile further comprises a geographical locale of prior purchases made by the potential customers.

20. The apparatus for identifying potential customers as in claim 15 wherein the customer profile further comprises a subject matter of prior purchases made by the potential customers.
